(19) United States
(12) Patent Application Publication
(10) Pub. No.: US 2022/0033215 A1
(43) Pub. Date: Feb. 3, 2022

(54) ELEVATOR MOTION CONTROL AFTER ELECTRICAL PROTECTIVE DEVICE ACTIVATION

(71) Applicant: OTIS ELEVATOR COMPANY, Farmington, CT (US)

(72) Inventors: Richard L. Hollowell, West Hartford, CT (US); Randy Roberts, Hebron, CT (US); Xiaodong Luo, South Windsor, CT (US); Benjamin J. Watson, Collinsvile, CT (US); Marcin Wroblewski, Burlington, CT (US)

(21) Appl. No.: 16/945,829

(22) Filed: Aug. 1, 2020

(51) Int. Cl. B66B 1/30; B66B 5/06; B66B 1/32

(52) U.S. Cl. CPC B66B 1/30; B66B 1/32; B66B 5/06

(57) ABSTRACT

An illustrative example embodiment of a device for controlling movement of an elevator car includes an emergency stopping supervisor, such as a processor and memory associated with the processor. The emergency stopping supervisor is configured to: determine when an indication from an electrical protection device indicates that the elevator car should be stopped, issue a command for the elevator car to move at a reduced speed, monitor continued movement of the elevator car at the reduced speed, and continue to allow the elevator car to move at the reduced speed until a selected condition exists or immediately cause the elevator car to stop if the reduced speed is not within a predetermined range.

### BACKGROUND

Elevator systems are designed to carry passengers using a desired motion profile to provide an expected ride quality. Elevator systems include a variety of devices to address a situation in which the elevator system cannot operate as expected or required. For example, electrical protective devices (EPDs) provide indications of conditions such as elevator car speed or position, door lock status, and pit switch status. When a limit is exceeded or a status is undesired, for example, the corresponding EPD sends a signal to cut power to the machine motor and immediately drop the machine brake.

While the traditional approach of bringing the car to a stop by cutting power to the machine places the car in a safe condition, it is not without drawbacks. One issue with cutting the power supply in response to an EPD indication is that the elevator car may come to an abrupt stop and any passenger in the car may be alarmed or experience discomfort because of the rapid deceleration. Additionally, the passenger may not be able to exit the elevator car if it stops at a position where the car doors cannot be opened.

It would be useful to be able to respond to EPD activation in a manner that reduces the risk of passenger discomfort or entrapment while still addressing the situation giving rise to the EPD activation.

### SUMMARY

An illustrative example embodiment of a device for controlling movement of an elevator car includes an emergency stopping supervisor, such as a processor and memory associated with the processor. The emergency stopping supervisor is configured to: determine when an indication from an electrical protection device indicates that the elevator car should be stopped, issue a command for the elevator car to move at a reduced speed, monitor continued movement of the elevator car at the reduced speed, and continue to allow the elevator car to move at the reduced speed until a selected condition exists or immediately cause the elevator car to stop if the reduced speed is not within a predetermined range.

In an example embodiment having at least one feature of the device of the previous paragraph, the emergency stopping supervisor immediately causes the elevator car to stop by disconnecting power from a machine brake and motor associated with the elevator car.

In an example embodiment having at least one feature of the device of any of the previous paragraphs, the emergency stopping supervisor causes the elevator car to move at the reduced speed by commanding a motion controller to slow down the elevator car.

In an example embodiment having at least one feature of the device of any of the previous paragraphs, the emergency stopping supervisor determines whether the indication from the electrical protection device requires immediately disconnecting power from a machine brake and motor associated with the elevator car as a prerequisite to causing the elevator car to move at the reduced speed until the selected condition exists.

In an example embodiment having at least one feature of the device of any of the previous paragraphs, the selected condition is one of the elevator car reaching a selected position or the elevator car coming to a stop in a controlled manner.

In an example embodiment having at least one feature of the device of any of the previous paragraphs, the emergency stopping supervisor changes the reduced speed to decelerate the elevator car at a selected rate as the elevator car approaches a selected position or a complete stop.

In an example embodiment having at least one feature of the device of any of the previous paragraphs, the emergency stopping supervisor disconnects power from a motor and brake associated with the elevator car after the selected condition exists.

An illustrative example embodiment of a method of controlling movement of an elevator car by an emergency stopping supervisor includes using the emergency stopping supervisor for: determining when an indication from an electrical protection device indicates that the elevator car should be stopped, issuing a command for the elevator car to move at a reduced speed, monitoring continued movement of the elevator car at the reduced speed, and continuing to allow the elevator car to move at the reduced speed until a selected condition exists or immediately causing the elevator car to stop if the reduced speed is not within a predetermined range.

In an example embodiment having at least one feature of the method of any of the previous paragraphs, immediately causing the elevator car to stop comprises disconnecting power from a machine brake and motor associated with the elevator car.

In an example embodiment having at least one feature of the method of any of the previous paragraphs, issuing the command for the elevator car to move at the reduced speed comprises commanding a motion controller to slow down the elevator car.

An example embodiment having at least one feature of the method of any of the previous paragraphs includes determining whether the indication from the electrical protection device requires immediately disconnecting power from a machine brake and motor associated with the elevator car as a prerequisite to issuing the command for the elevator car to move at the reduced speed until the selected condition exists.

In an example embodiment having at least one feature of the method of any of the previous paragraphs, the selected condition includes the elevator car reaching a selected position or the elevator car coming to a stop in a controlled manner.

An example embodiment having at least one feature of the method of any of the previous paragraphs includes changing the reduced speed to decelerate the elevator car at a selected rate as the elevator car approaches a selected position or a complete stop.

An example embodiment having at least one feature of the method of any of the previous paragraphs includes disconnecting power from a motor and brake associated with the elevator car after the selected condition exists.

The various features and advantages of at least one disclosed example embodiment will become apparent to those skilled in the art from the following detailed description. The drawings that accompany the detailed description can be briefly described as follows.

### BRIEF DESCRIPTION OF THE DRAWINGS

FIG. 1 schematically illustrates selected portions of an example embodiment of an elevator system.

FIG. 2 is a flow chart diagram summarizing an elevator car movement control strategy according to a disclosed example embodiment.

### DETAILED DESCRIPTION

A disclosed example embodiment includes a controlled stop in response to EPD activation when an immediate stop is not necessary. An emergency stopping supervisor determines when an EPD activation indicates a need to stop the elevator. The emergency stopping supervisor communicates with the elevator motion controller to accomplish a deceleration of the elevator car in a controlled manner until the elevator is in a selected condition. The controlled stop may bring the elevator car to a previously selected destination floor, a nearby landing or another location in the hoistway in a controlled manner During the controlled stop, the emergency stopping supervisor monitors the speed of the elevator car and instigates an immediate stop if the speed is outside of an acceptable range.

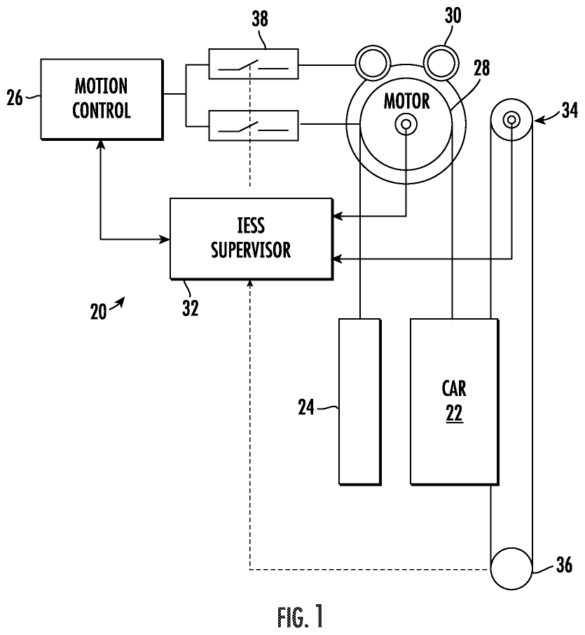

FIG. 1 schematically illustrates selected portions of an elevator system 20. An elevator car 22, which is associated with a counterweight 24, is configured to carry passengers to provide elevator service. An elevator motion controller 26 controls operation of a machine including a motor 28 and a machine brake 30 to control movement and position of the elevator car 22. The elevator motion controller 26 is programmed or otherwise configured to control the motor 28 and brake 30 to move the elevator car 22 and counterweight 24 at a contract speed according to a designed motion profile. Other embodiments do not include a counterweight.

An intelligent emergency stopping system (IESS) includes an emergency stopping supervisor 32 that determines when an emergency stop of the elevator car 22 is required based on an indication from at least one electrical protective device (EPD). The emergency stopping supervisor 32 includes a computing device, such as at least one processor and memory associated with the processor. The emergency stopping supervisor 32 is programmed or otherwise configured to communicate with the elevator motion controller 26 and monitor the movement of the elevator car 22 during a controlled stop.

A governor 34 operates in a known manner based on the speed of movement of the elevator car 22. A tension frame 36 of the governor 34 includes an EPD that provides a signal to the emergency stopping supervisor 32. Other EPDs, such as door lock switches, limit switches or a pit switch, will be included in most elevator systems as required by local codes. The EPD associated with the tension frame 36 is used as an example for discussion purposes.

Switches 38 selectively disconnect the motor 28 and machine brake 30 from a source of power. Whenever power is cut by opening the switches 38, for example, the machine brake 30 drops and prevents further movement of the elevator car 22. EPD activation typically requires disconnecting the machine from power until the condition indicated by the EPD has been addressed by an appropriate individual.

The emergency stopping supervisor 32 allows for selectively controlling the switches 38 in a manner that allows for some continued movement of the elevator car 22 under some circumstances. This approach is different than the typical approach of immediately disconnecting the machine from power every time that an EPD is activated.

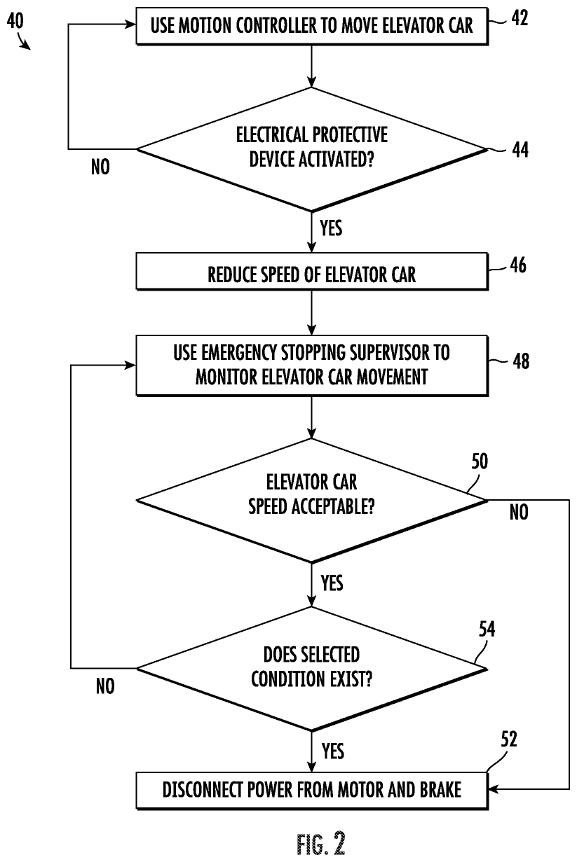

FIG. 2 is a flow chart diagram 40 that summarizes an example control method. At 42, the motion controller 26 controls movement and position of the elevator car 22 in a normal manner. At 44, the emergency stopping supervisor 32 determines whether any EPD has been activated or an EPD provides an indication that the power to the machine should be turned off. If no EPD has been activated, the elevator control at 42 continues.

In the event that an EPD has been activated in response to a condition of the elevator system 20, the emergency stopping supervisor 32 commands the motion controller 26 to immediately reduce the speed of the elevator car 22 at 46. In other words, once a positive determination is made at 44, the emergency stopping supervisor 32 sends a signal to the motion controller 26 that interrupts or changes the way in which the motion controller 26 controls movement of the elevator car 22. In the illustrated example embodiment, the motion controller 26 is responsible for movement of the elevator car 22 and the emergency stopping supervisor 32 is responsible for monitoring the movement of the elevator car at 46 and 48. Having the emergency stopping supervisor 32 perform the monitoring function addresses a situation in which the EPD activation was related to a condition of the motion controller 26 or the monitoring function of the motion controller 26 is somehow compromised.

The emergency stopping supervisor 32 determines at 50 whether the reduced speed of the elevator car 22 is within an acceptable range. If the condition of the elevator system 20 is such that the elevator car 22 cannot be sufficiently slowed down, the determination at 50 has a negative result and the emergency stopping supervisor 32 uses the switches 38 to disconnect the motor 28 and machine brake 30 from power. At 52, the machine brake 30 drops, brings the elevator car 22 to an immediate stop and prevents further movement of the elevator car 22 until an appropriate individual resets the system.

When the determination at 50 is positive and the elevator car 22 is moving at an acceptably slow speed, the emergency stopping supervisor 32 determines whether a selected condition exists at 54. The selected condition may vary depending on the particular embodiment or control strategy. For example, the selected condition includes the elevator car 22 reaching a selected position or coming to a complete stop in a controlled manner.

In some embodiments, activation of an EPD causes the emergency stopping supervisor 32 to select a position for the elevator car 22 to reach using a reduced travel speed. The position selected by the emergency stopping supervisor 32 may be the terminal landing of the currently scheduled run, a default parking position, a nearby landing that can be reached, or another position within the hoistway where the elevator car will stop based on the deceleration rate. The selected position in the illustrated example is a landing where the doors of the elevator car 22 can be opened to allow any passengers on board to exit the elevator car 22. The emergency stopping supervisor 32 in the example embodiment changes the reduced speed to decelerate the elevator car 22 at a selected rate as the elevator car 22 approaches the selected position.

If the elevator car 22 has not yet arrived at the selected position or come to a complete stop, the emergency stopping supervisor 32 continues to monitor movement of the elevator car 22 at 48 and ensures that the elevator car 22 is moving at an acceptably slow speed at 50. Once the selected condition exists, the emergency stopping supervisor 32 uses the switches 38 to disconnect the motor 28 and brake 30 from power. The elevator system will remain in that condition, preventing further movement of the elevator car 22, until an appropriate individual takes whatever action is required to reset or repair the portion of the system that caused the EPD activation.

The approach summarized in FIG. 2 allows for avoiding an abrupt stop of the elevator car 22 in response to EPD activation. Instead, the elevator car 22 is immediately slowed down at a rate that avoids passenger discomfort. The emergency stopping supervisor 32 then monitors continued movement of the elevator car 22 until the condition selected by the emergency stopping supervisor 32 exists to ensure that the elevator car 22 eventually stops in a safe manner.

In the event that the continued movement of the elevator car 22 is not within a predetermined speed limit, the emergency stopping supervisor 32 immediately disconnects the motor 28 and brake 30 from power, for example by opening the switches 38, to bring the elevator car 22 to an immediate stop. By continuing to monitor the speed of movement of the elevator car 22, the emergency stopping supervisor 32 monitors elevator car movement independent of any speed determination from the motion controller 26 because the source of the EPD activation may make any such determination from the motion controller 26 unreliable. The motion controller 26 receives a command from the emergency stopping supervisor 32 and the latter monitors movement of the elevator car 22 to ensure that the motion controller 26 is following the command to bring the elevator car 22 to a stop.

The example emergency stopping supervisor 32 is programmed or otherwise configured to determine whether an EPD indication allows for taking the approach of FIG. 2. For example, some EPD activations indicate a condition that will require immediately disconnecting the power from the motor 28 and brake 30 but others will allow for delaying the disconnect while controlling the elevator car speed as described above. The emergency stopping supervisor 32 determines which EPD has been activated and only uses the approach summarized by the flowchart 40 in response to selected EPDs.

Having the emergency stopping supervisor 32 operate in the manner of the disclosed embodiment allows for meeting code requirements to respond to EPD activation and disconnecting power from the motor 28 and brake 30 without having to immediately bring the elevator car to an abrupt stop. This manner of stopping the elevator car 22 provides a comfortable experience for any passenger in the elevator car 22 and increases the likelihood that the passengers can exit the elevator car 22 when it stops, which is a significant improvement over always immediately stopping the elevator car 22 every time an EPD provides an indication that requires disconnecting the motor 28 and brake 30 from power.

The preceding description is exemplary rather than limiting in nature. Variations and modifications to the disclosed examples may become apparent to those skilled in the art that do not necessarily depart from the essence of this invention. The scope of legal protection given to this invention can only be determined by studying the following claims.

We claim:

1. A device for controlling movement of an elevator car, comprising an emergency stopping supervisor including at least one processor and memory associated with the processor, the emergency stopping supervisor being configured to:
determine when an indication from an electrical protection device indicates that the elevator car should be stopped,
issue a command for the elevator car to move at a reduced speed,
monitor continued movement of the elevator car at the reduced speed, and
allow the elevator car to continue to move at the reduced speed until a selected condition exists or
immediately cause the elevator car to stop if the reduced speed is not within a predetermined range.

2. The device of claim 1, wherein the emergency stopping supervisor immediately causes the elevator car to stop by disconnecting power from a machine brake and motor associated with the elevator car.

3. The device of claim 1, wherein the emergency stopping supervisor causes the elevator car to move at the reduced speed by commanding a motion controller to slow down the elevator car.

4. The device of claim 1, wherein the emergency stopping supervisor determines whether the indication from the electrical protection device requires immediately disconnecting power from a machine brake and motor associated with the elevator car as a prerequisite to causing the elevator car to move at the reduced speed until the selected condition exists.

5. The device of claim 1, wherein the selected condition is one of the elevator car reaching a selected position or the elevator car coming to a stop in a controlled manner.

6. The device of claim 1, wherein the emergency stopping supervisor changes the reduced speed to decelerate the elevator car at a selected rate as the elevator car approaches a selected position or a complete stop.

7. The device of claim 1, wherein the emergency stopping supervisor disconnects power from a motor and brake associated with the elevator car after the selected condition exists.

8. A method of controlling movement of an elevator car by an emergency stopping supervisor including at least one processor and memory associated with the processor, the method comprising using the emergency stopping supervisor for:
determining when an indication from an electrical protection device indicates that the elevator car should be stopped,
issuing a command for the elevator car to move at a reduced speed,
monitoring continued movement of the elevator car at the reduced speed, and
continuing to allow the elevator car to move at the reduced speed until a selected condition exists or
immediately causing the elevator car to stop if the reduced speed is not within a predetermined range.

9. The method of claim 8, wherein immediately causing the elevator car to stop comprises disconnecting power from a machine brake and motor associated with the elevator car.

10. The method of claim 8, wherein issuing the command for the elevator car to move at the reduced speed comprises commanding a motion controller to slow down the elevator car.

11. The method of claim 8, comprising determining whether the indication from the electrical protection device requires immediately disconnecting power from a machine brake and motor associated with the elevator car as a prerequisite to issuing the command for the elevator car to move at the reduced speed until the selected condition exists.

12. The method of claim 8, wherein the selected condition includes the elevator car reaching a selected position or the elevator car coming to a stop in a controlled manner.

13. The method of claim 8, comprising changing the reduced speed to decelerate the elevator car at a selected rate as the elevator car approaches a selected position or a complete stop.

14. The method of claim 8, comprising disconnecting power from a motor and brake associated with the elevator car after the selected condition exists.
